(19) United States
(12) Patent Application Publication
(10) Pub. No.: US 2002/0151349 A1
(43) Pub. Date: Oct. 17, 2002

(54) Gaming machine with visual and audio indicia changed over time

(76) Inventor: Shridhar P. Joshi, Skokie, IL (US)

Correspondence Address: JENKENS & GILCHRIST, P.C., 225 WEST WASHINGTON, SUITE 2600, CHICAGO, IL, 60606, US

(21) Appl. No.: 10/157,514

(22) Filed: May 29, 2002

Related U.S. Application Data
(62) Division of application No. 09/679,093, filed on Oct. 4, 2000.

(51) Int. Cl. A63F 13/00

(52) U.S. Cl. 463/20

(57) ABSTRACT

A gaming machine having features for increasing player appeal is set forth. The machine generally includes a processor, a display, and a memory device. The processor monitors time signals from a clock and randomly selects one of a plurality of outcomes of the gaming machine in response to a wager amount. The display displays visual elements to be viewed by the player. The memory device is coupled to the processor and stores at least two data sets for producing at least two different types of visual elements. The processor selects one of at least two data sets in response to the processor monitoring a time signal corresponding to a predetermined time. The two different types of visual elements may be of a standard motif and a holiday motif, and the predetermined time is the holiday or one or more days before and/or after the holiday. Alternatively, the predetermined time can be at least one minute within one day, and the corresponding visual elements can be related to the time of the day. Or, the predetermined time can be a season of the year and the corresponding visual elements can be indicative of the season. The gaming machine may also include audio speakers and audio elements that replace the changing visual elements, or audio and video elements can be displayed in unison as a function of the time. The machine may also contemplate maintaining player appeal by providing a modified payout structure as a function of time.

### FIELD OF THE INVENTION

The present invention relates generally to gaming machines and, more particularly, to a gaming machine having visual and sound indicia that are automatically modified as a function of real time, such as the time of day, the season of the year, or a holiday season.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Consequently, shrewd operators strive to employ the most entertaining and exciting machines available because such machines attract frequent play and, hence, increase profitability to the operator. Accordingly, in the competitive gaming machine industry, there is a continuing need for gaming machine manufacturers to produce new types of games, or enhancements to existing games, which will attract frequent play by enhancing the entertainment value and excitement associated with the game.

One concept which has been successfully employed to enhance the entertainment value of a game is that of a “secondary” or “bonus” game which may be played in conjunction with a “basic” game. The bonus game may comprise any type of game, either similar to or completely different from the basic game, which is entered upon the occurrence of a selected event or outcome of the basic game. Such a bonus game produces a significantly higher level of player excitement than the basic game because it provides a greater expectation of winning than the basic game and is accompanied by more attractive or unusual video displays and/or audio.

While the bonus game concept offers advantages of player appeal and excitement relative to other known games, there is a continuing need to develop new features for gaming machines to satisfy the demands of players and operators. Preferably, such new features will maintain, or even further enhance, the level of player excitement offered by bonus games heretofore known in the art. The present invention is directed to satisfying these needs.

### SUMMARY OF THE INVENTION

A gaming machine includes a processor, a display, and a memory device. The processor monitors time signals from a clock and randomly selects one of a plurality of outcomes of the gaming machine in response to a wager amount. The display displays visual elements to be viewed by the player. The memory device is coupled to the processor and stores at least two data sets for producing at least two different types of visual elements. The processor selects one of at least two data sets in response to the processor monitoring a time signal corresponding to a predetermined time.

The two different types of visual elements may be of a standard motif and a holiday motif, and the predetermined time is the holiday or one or more days before and/or after the holiday. The holiday may be one of many widely recognized societal holidays, such as Valentine's Day, St. Patrick's Day, Mardi Gras, Easter, the 4th of July, Halloween, Thanksgiving, Christmas, New Year's Eve, and New Year's Day.

Alternatively, the predetermined time can be at least one minute within one day, and the corresponding visual elements can be related to the time of day. The predetermined time can also be a season of the year, and the corresponding visual elements can be indicative of that season.

In other alternatives, the gaming machine includes audio speakers and audio elements can replace the visual elements, or audio and visual elements can be displayed in unison as a function of the time.

The present invention also contemplates several novel methods of operating a gaming machine that is controlled by a processor to increase player appeal. For example, one method includes the steps of displaying a plurality of standard visual elements, monitoring real time, and displaying a plurality of modified visual elements in response to the real time being a predetermined time. The plurality of modified visual elements have a theme that is indicative of a commonly known societal event associated with the predetermined time.

In a further alternative to maintain player appeal, the gaming machine performs the steps of providing a standard payout structure having a payback percentage, monitoring real time, and replacing, in response to the real time being a predetermined time, the standard payout structure with a modified payout structure. The modified payout structure has a payback percentage that is the same as the standard payout structure.

In yet a further alternative, the method includes storing a plurality of visual element data sets in a memory device to be accessed by the processor with each of the plurality of visual element data sets corresponding to a different visual element motif, displaying each of the visual element motifs for a selected period of time while the gaming machine is operational, and determining which one of the visual element motifs is the favorite by monitoring, with the controller, wager inputs while each of the visual element motifs is activated. Once the favorite is known, then the machine displays the favorite visual element motif for a larger portion of the total operating time. This player appeal monitoring system can be expanded such that each machine in a bank of common machines displays different visual element motifs. The visual element motif of the machine(s) which is the favorite, as measured by wager inputs, is then displayed on more of the machines in the bank.

The above summary of the present invention is not intended to represent each embodiment or every aspect of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a simplified front view of a slot machine embodying the present invention.

FIG. 2 is a block diagram of a control system suitable for operating the gaming machine in FIG. 1.

FIG. 3 is a display screen capture associated with a five-reel, nine-line basic game that is played on the gaming machine in FIG. 1.

FIGS. 4a and 4b are a pay table for various winning symbol combinations that may occur in the basic game of the gaming machine in FIG. 1.

FIGS. 5-9 are display screen captures associated with a bonus game with mystery.

FIG. 10 is a pay table for a primary bonus awarded for finding a guilty character from suspects shown on the display screen capture in FIGS. 5-8, where the number of suspects depends upon the start-bonus outcome that triggered the bonus game.

FIG. 11 is a multiplier table for a payout multiplier for finding a hiding place of the guilty character in a hideout shown on the display screen capture in FIG. 9, where the number of hiding places depends upon the start-bonus outcome that triggered the bonus game.

FIG. 12 illustrates a slot machine where the symbols on the video display have been modified to a Christmas holiday theme.

FIG. 13 illustrates the display where a bonus game has been enacted, as shown in FIG. 5, but the features of the display are of a Christmas holiday theme.

FIG. 14 illustrates the display where a bonus game has been enacted, as shown in FIG. 5, but the features of the display are of a Halloween holiday theme.

FIG. 15 illustrates the display where a bonus game has been enacted, as shown in FIG. 5, but the features of the display are of a summer seasonal theme.

FIG. 16 illustrates the display where a bonus game has been enacted, as shown in FIG. 5, but the features of the display are of a nighttime theme.

FIG. 17 illustrates a bank of gaming machines that are all connected to a controller, whereby each gaming machine can have a different theme and the most popular of the themes, as measured by the amount of wager input, can be determined by the controller.

FIGS. 18A and B illustrate flow charts of the algorithms used to change the visual and audio elements.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

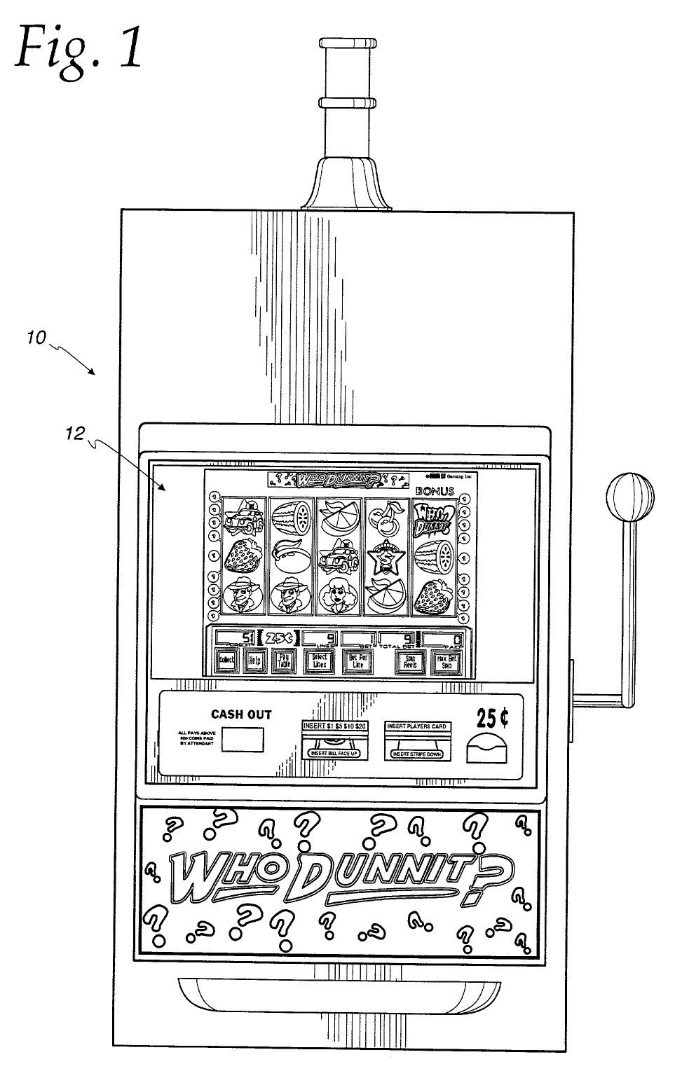

Turning now to the drawings and referring initially to FIG. 1, a video gaming machine 10 is depicted that may be used to implement a bonus game according to the present invention. The gaming machine 10 includes a video display 12 that may comprise a dot matrix, CRT, LED, LCD, electro-luminescent display, or generally any type of video display known in the art. In the illustrated embodiment, the gaming machine 10 is an “upright” version in which the video display 12 includes a touch screen and is oriented vertically relative to the player. It will be appreciated, however, that any of several other models of gaming machines are within the scope of the present invention, including, for example, a “slant-top” version in which the video display is slanted at about a 30° angle toward the player, or gaming machines that is include mechanical, rather than video, displays.

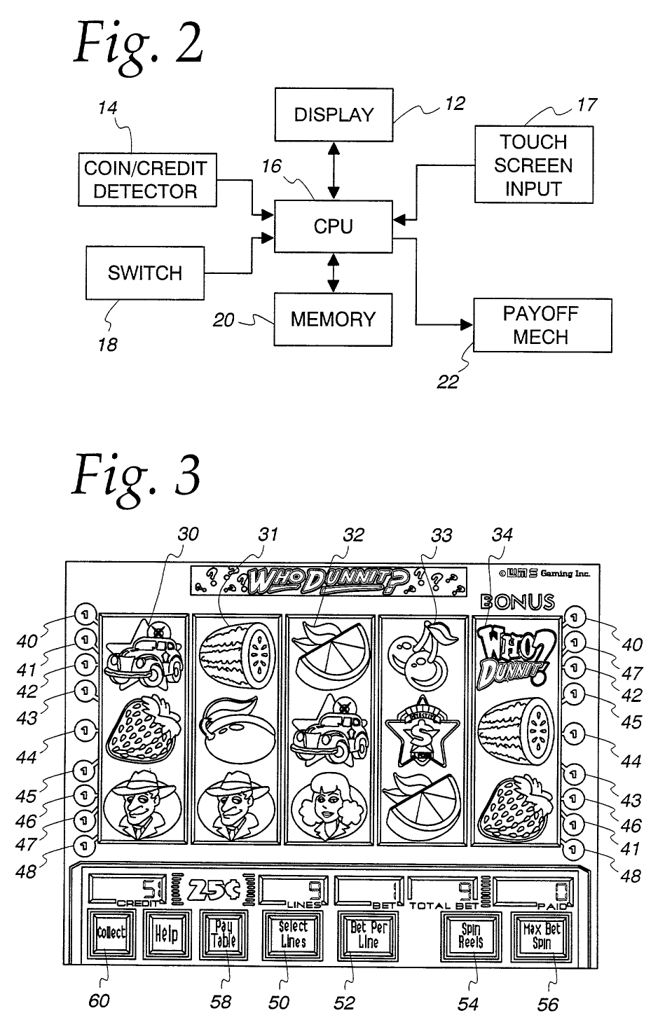

In one embodiment, the gaming machine 10 is operable to play a game entitled WHO DUNNIT?™ having a mystery theme. The WHO DUNNIT?™ game features a basic game in the form of a slot machine with five simulated spinning reels (see FIG. 3) and a bonus game with strategy options directing game activities on the video display 12. It will be appreciated, however, that the gaming machine 10 may be implemented with games other than the WHO DUNNIT?™ game and/or with several alternative game themes.

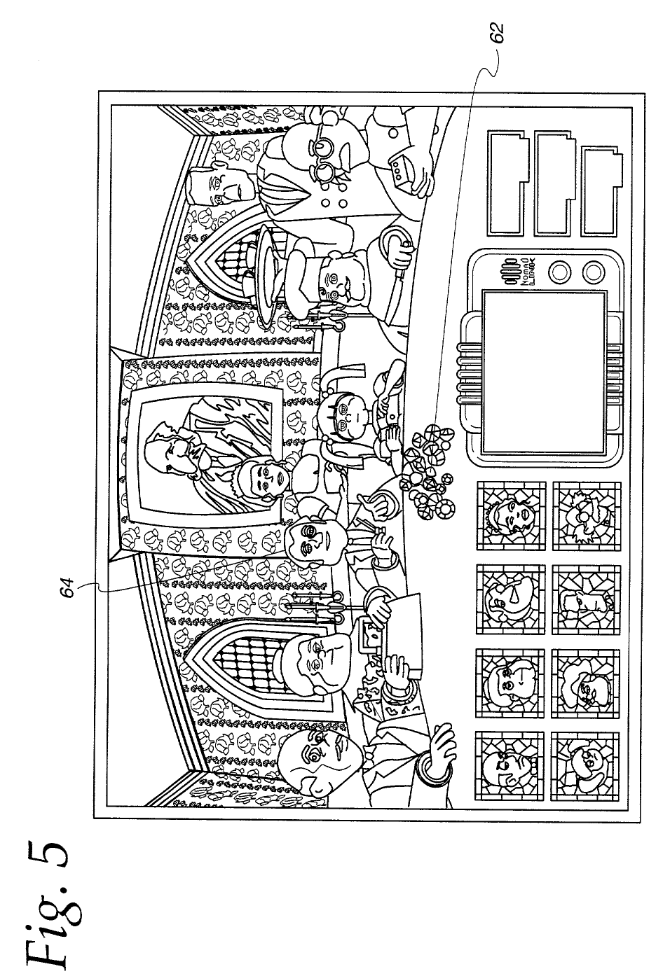

FIG. 2 is a block diagram of a control system suitable for operating the gaming machine 10. Coin/credit detector 14 signals a CPU 16 when a player has inserted a number of coins or played a number of credits. Then, the CPU 16 executes a game program which causes the video display 12 to display the basic game that includes simulated reels with symbols displayed thereon (see FIG. 3). The player may select the number of paylines to play and the amount to wager via touch screen input keys 17. The basic game commences in response to the player activating a switch 18 (e.g., by pulling a lever or pushing a button), causing the CPU 16 to set the reels in motion, randomly select a game outcome, and then stop the reels to display symbols corresponding to the pre-selected game outcome. In one embodiment, certain basic game outcomes cause the CPU 16 to enter a bonus mode, which causes the video display 12 to show a bonus game. The display screens associated with the WHO DUNNIT™ bonus game will be described in detail in relation to FIGS. 5-9.

A system memory 20 stores control software, operational instructions, and data associated with the gaming machine 10. In one embodiment, the system memory 20 comprises a separate read-only memory (ROM) and battery-backed random-access memory (RAM). It will be appreciated, however, that the system memory 20 may be implemented on any of several alternative types of memory structures or may be implemented on a single memory structure. A payoff mechanism 22 is operable in response to instructions from the CPU 16 to award a payoff of coins or credits to the player in response to certain winning outcomes which may occur in the basic game or bonus game. The payoff amounts corresponding to certain combinations of symbols in the basic game are predetermined according to a pay table stored in system memory 20. The payoff amounts corresponding to certain outcomes of the bonus game are also stored in system memory 20.

As shown in FIG. 3, the WHO DUNNIT?™ basic game is implemented on the video display 12 on five video simulated spinning reels 30, 31, 32, 33 and 34 (hereinafter “reels”) with nine paylines 40-48. Each of the paylines 40-48 extend through one symbol on each of the five reels 30-34. Generally, game play is initiated by inserting a number of coins or playing a number of credits, causing the CPU 16 (FIG. 2) to activate a number of paylines corresponding to the number of coins or credits played. In one embodiment, the player selects the number of paylines (between one and nine) to play by pressing a “Select Lines” key 50 on the video display 12. The player then chooses the number of coins or credits to bet on the selected paylines by pressing the “Bet Per Line” key 52.

After activation of the paylines, the reels 30-34 may be set in motion by touching the “Spin Reels” key 54 or, if the player wishes to bet the maximum amount per line, by using the “Max Bet Spin” key 56 on the video display 12. Alternatively, other mechanisms, such as, for example, a lever or push button, may be used to set the reels in motion. The CPU 16 uses a random number generator (not shown) to select a game outcome (e.g., “basic” game outcome) corresponding to a particular set of reel “stop positions.” The CPU 16 then causes each of the video reels 30-34 to stop at the appropriate stop position. Video symbols are displayed on the reels 30-34 to graphically illustrate the reel stop positions and indicate whether the stop positions of the reels represent a winning game outcome. Winning basic game outcomes (e.g., symbol combinations resulting in payment of coins or credits) are identifiable to the player by a pay table. In one embodiment, the pay table is affixed to the machine 10 and/or displayed by the video display 12 in response to a command by the player (e.g., by pressing the “Pay Table” button 58). A winning basic game outcome occurs when the symbols appearing on the reels 30-34 along an active payline correspond to one of the winning combinations on the pay table. If the displayed symbols stop in a winning combination, the game credits the player with an amount corresponding to the award in the pay table for that combination multiplied by the amount of credits bet on the winning payline. The player may collect the amount of accumulated credits by pressing the “Collect” button 60.

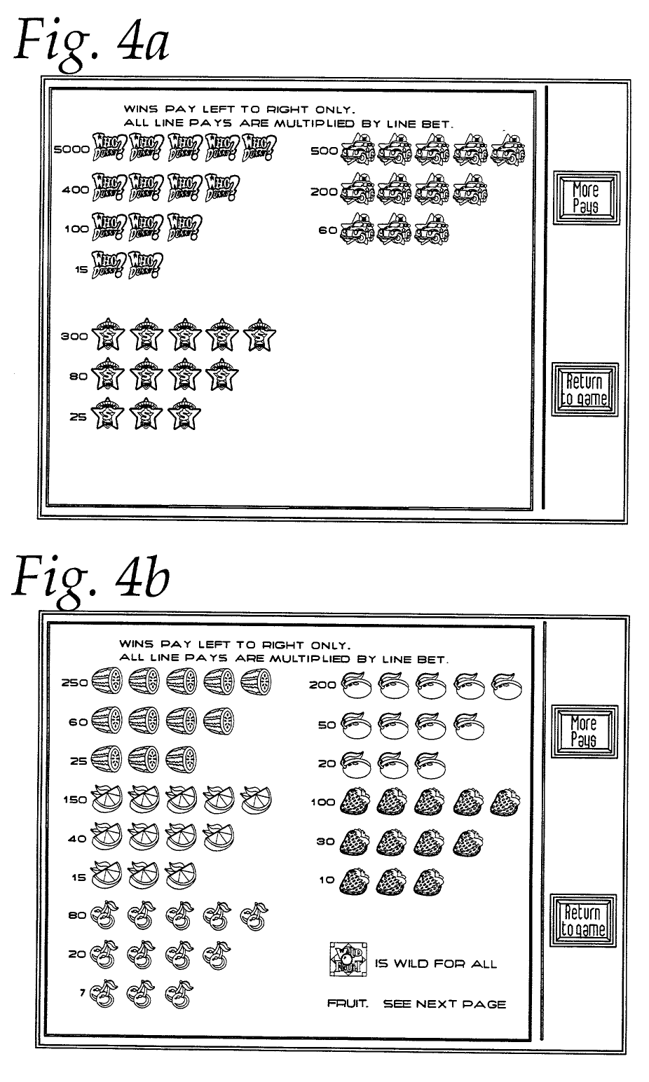

FIGS. 4a and 4b depict the pay table for the WHO DUNNIT?™ basic game. The pay table enables the player to view the winning combinations and their associated payoff amounts. From the pay table, it can be seen that the WHO DUNNIT?™ basic game includes the following reel symbols that can lead to a payoff in the basic game: WHO DUNNIT, DETECTIVE CAR, BADGE, CHERRY, MELON, PLUM, ORANGE, STRAWBERRY, and MAGNIFYING GLASS.

Included among the plurality of basic game outcomes are a plurality of different start-bonus outcomes for starting play of a bonus game. A start-bonus outcome may be defined in any number of ways. For example, a start-bonus outcome occurs when a special start-bonus symbol or a special combination of symbols appears on one or more of the reels 30-34 in any predetermined display position. The appearance of a start-bonus outcome causes the processor to shift operation from the basic game to a bonus game.

The WHO DUNNIT?™ bonus game is triggered by lining up three DETECTIVE symbols, three SIDEKICK symbols, or any mix of three of these start-bonus symbols on an active payline. In other words, the start-bonus outcomes are the following combinations of start-bonus symbols appearing, in any order, on an active payline: (1) DETECTIVE, DETECTIVE, DETECTIVE; (2) DETECTIVE, DETECTIVE, SIDEKICK; (3) DETECTIVE, SIDEKICK, SIDEKICK; and (4) SIDEKICK, SIDEKICK, SIDEKICK. In FIG. 3, for example, the combination DETECTIVE (reel 30), DETECTIVE (reel 31), and SIDEKICK (reel 32) is on the payline 46. If that payline is active, the bonus game would be triggered. In the illustrated embodiment, the DETECTIVE and SIDEKICK symbols do not appear in the pay table in FIG. 4 and, therefore, cannot generate a winning basic game outcome. These symbols do, however, provide start-bonus outcomes for triggering the WHO DUNNIT?™ bonus game.

In response to starting the WHO DUNNIT?™ bonus game, the video display 12 shows the bonus game screen in FIG. 5. The scene on the bonus screen includes eight different characters around a table, some seated and some standing. The characters may, for example, include a Shady Lawyer, Butler, French Maid, Italian Chef, Old Lady (the Widow), Accountant, Professor (Mad Scientist), and Little Girl. Placed in the center of the table will be some item of value 62. The scene may be of a will being read by an attorney and all the appropriate members have been gathered to divide up the estate. In summary, the item is stolen by one of the members at the table and a player of the gaming machine becomes the detective who must now solve this crime. The object for the player is to take as few selections as possible to reveal the guilty character to the rest of the group. The fewer the selections, the greater the bonus.

Prior to the item being stolen, the characters are in a NORMAL MODE. The characters may “blink” their eyes but, essentially, they carry expressions of indifference. The Shady Lawyer 64 then gives a short introductory speech like “[w]e're here to distribute the estate of . . . ” During this speech, one or two of the characters may wink to give the player a false sense of knowledge about who committed the crime.

After the Shady Lawyer 64 finishes his speech, the video display turns black to indicate a “blackout” and then lightning flashes through windows. The light generated from the lightning highlights the characters. The player hears a scream, footsteps, and a door slam, at which time the screen fades back up to its normal lighting. The item that had been in the center of the table is now missing.

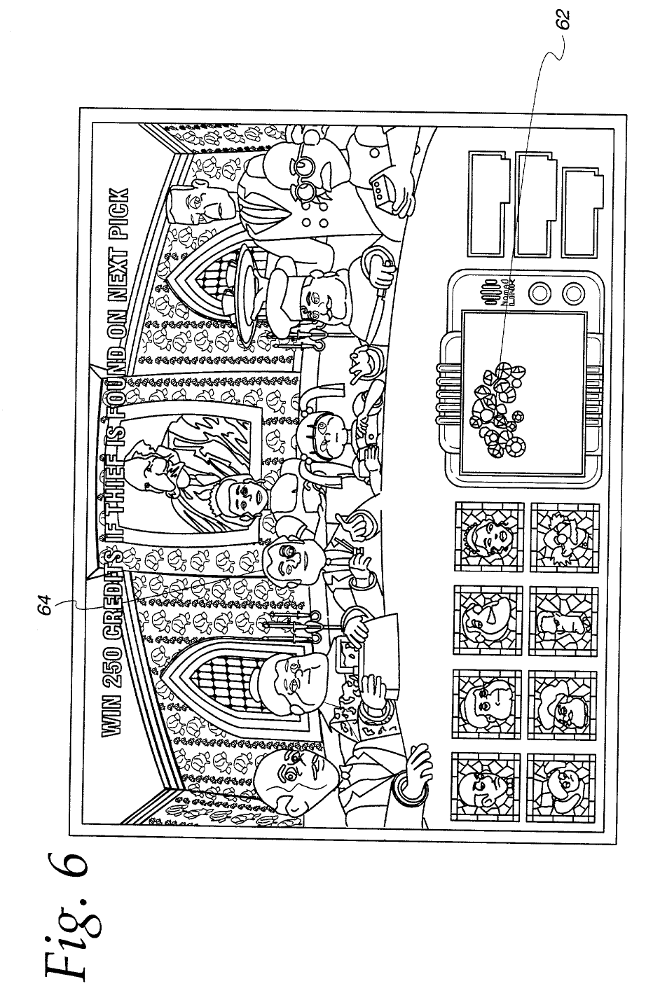

FIG. 6 depicts the bonus game screen after the item has been stolen. The characters are now in a SUSPECT MODE. In this mode, the characters have suspicious facial expressions with shifting eyes which avoid eye contact with the player. Some of the characters may perform some kind of idle animation to make them appear guilty. For example, the Italian Chef may fiddle with his knife, the Old Lady may clench her purse, the Professor may click his stopwatch, the Little Girl may play with her teddy bear, and the Shady Lawyer may tap a pen on his hand.

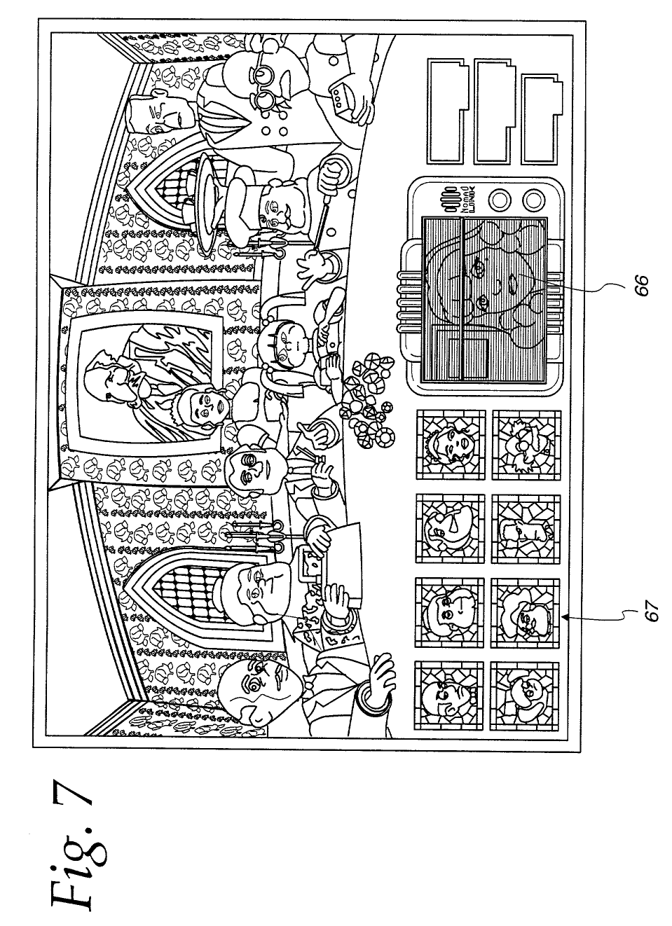

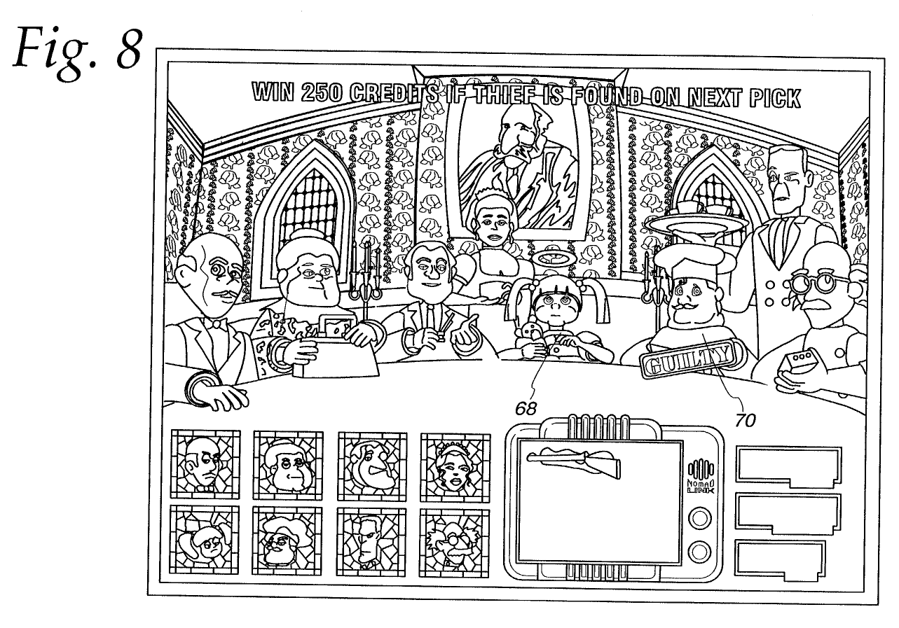

Referring to FIG. 7, if the WHO DUNNIT?™ bonus game was triggered by a start-bonus outcome including one or more SIDEKICK symbols, then a sidekick character 66 appears on the video display. At this time, the sidekick character 66 eliminates X number of characters by proclaiming them innocent and removing them from the suspect list, where X is equal to the number of SIDEKICK symbols in the start-bonus outcome that triggered the bonus game. For example, if the start-bonus outcome was the combination DETECTIVE, DETECTIVE, SIDEKICK in any order (see FIG. 3), then one of the eight characters is removed from the suspect list. If the start-bonus outcome was the combination DETECTIVE, SIDEKICK, SIDEKICK in any order, then two of the eight characters are removed from the suspect list. Finally, if the start-bonus outcome was the combination SIDEKICK, SIDEKICK, SIDEKICK, then three of the eight characters are removed from the suspect list. If the start-bonus outcome consisted solely of the combination of three DETECTIVE symbols, however, then the sidekick character 66 does not emerge.

Next, game control is transferred to the player, who can then select a character that he or she believes is guilty. Alternatively, the bonus game screen may include a menu panel 67 with color icons of five, six, seven, or eight characters (depending on the number of SIDEKICK symbols in the start-bonus outcome), and the player may select the character's icon in the menu panel. Icons of any characters removed from the suspect list by the sidekick character 66 are preferably grayed out or not shown. This gives the player the flexibility of either choosing the character directly or using the character's icon to make the player's choice. The fewer selections it takes the player to find the guilty character, the greater the bonus.

There are two possible outcomes once a character is chosen by the player-the character is either innocent or guilty. If the character is innocent, then the character undergoes an animated transition to innocence. Specifically, the character's icon from the menu panel is disabled, a new sprite is placed over the top of the character with a brighter lighting, and a halo is put above the character's head. The character may also speak one of three different phrases such as “I told you I didn't do it.” The innocent character cannot be chosen again. In FIG. 8, the Little Girl 68 has undergone a transition to innocence.

If the selected character is guilty, then the guilty character speaks one of three guilty phrases, is stamped guilty, and is given an appropriate facial expression. In FIG. 8, the Italian Chef 70 has undergone a transition to guilty. At this point, the processor occasionally triggers one or more additional bonus features discussed below. If none of these bonus features is triggered, however, the processor ends the bonus game and awards a primary bonus to the player. The video display may accompany the award of the primary bonus with animations celebrating the capture of the guilty suspect.

The three additional bonus features that can be triggered prior to awarding the primary bonus immediately upon selecting the guilty character are an accomplice feature, an additional stolen item feature, and a go-to-suspect's-hideout feature. Although the CPU 16 (FIG. 2) is programmed such that it is highly unlikely for more than one of these bonus features to occur in the bonus game, it is possible for one, two, or all three of these features to occur in the bonus game.

In the accomplice feature, the guilty character has an accomplice who the player must find for a supplemental bonus. The player finds the accomplice by continuing to select the characters as described above until the accomplice is found. Finding the accomplice adds the supplemental bonus to the primary bonus that was already awarded for finding the guilty character.

In the additional stolen item feature, the guilty character has another stolen item on him or her, such as another character's wallet, that awards the player with a supplemental bonus in addition to the primary bonus already awarded for finding the guilty character.

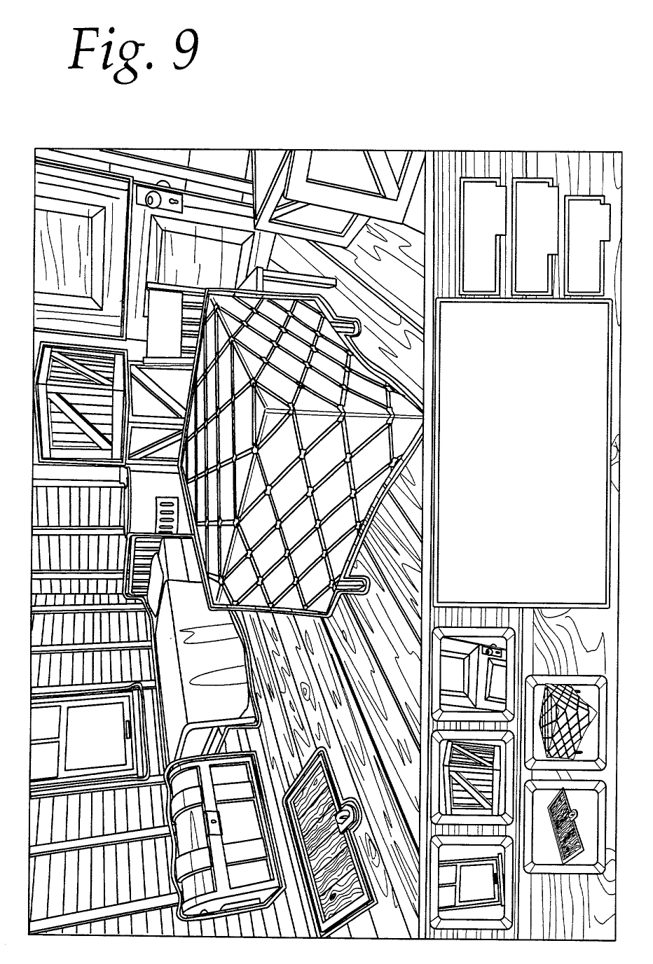

In the go-to-suspect's-hideout feature, which occurs very rarely, the guilty character says “I did it but you've got to catch me first” and flees the scene of the crime to his or her hideout. The player is then taken to the bonus screen in FIG. 9, which shows the guilty character's hideout with highlights around key areas such as a closet, table, chest, window, stove, trapdoor in the floor, etc. These highlights represent possible hiding places for the guilty character. The object of this bonus feature is to find the hiding place of the guilty character in as few selections as possible. The fewer the number of selections it takes the player to find the hiding place of the guilty character, the greater a payout multiplier. Finding the hiding place of the guilty character applies the multiplier to the total payout (including any basic and bonus game payouts) that were already awarded to the player.

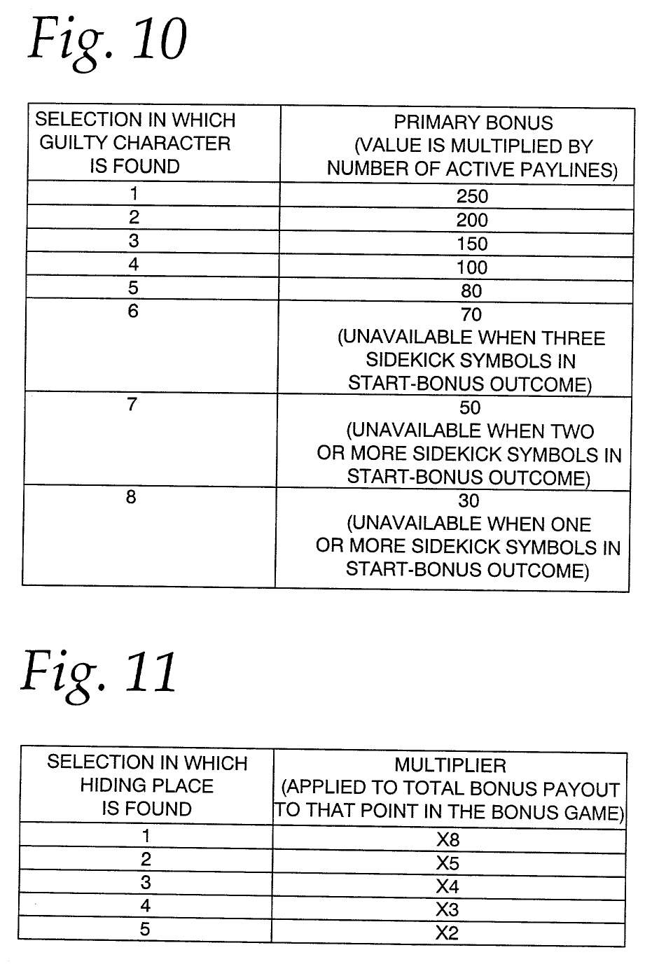

Referring now to FIG. 10, there is shown a pay table for the primary bonus awarded for finding the guilty character from the suspects shown on the display screen captures in FIGS. 5-8. The player is awarded a primary bonus based on the number of selections required to find the guilty character. The fewer the number of selections it takes the player to find the guilty character, the greater the primary bonus. If a player finds the guilty character with his or her first selection, the player is awarded a primary bonus of 250 credits multiplied by the number of active paylines; if the player finds the guilty character with his or her second selection, the player is awarded a primary bonus of 200 credits multiplied by the number of active paylines; if the player finds the guilty character with his or her third selection, the player is awarded a primary bonus of 150 credits multiplied by the number of active paylines; and so on.

As discussed above, the number of selectable suspects is reduced by one for each SIDEKICK symbol appearing in the start-bonus outcome that triggered the bonus game. Therefore, the number of available primary bonuses is reduced by one, starting from the lowest primary bonus appearing in the pay table, for each SIDEKICK symbol appearing in the start-bonus outcome. For example, if the start-bonus outcome includes one SIDEKICK symbol, the lowest primary bonus of 30 credits per active payline is unavailable to the player; if the start-bonus outcome includes two SIDEKICK symbols, the two lowest primary bonuses of 30 and 50 credits per active payline are unavailable to the player; and if the start-bonus outcome includes three SIDEKICK symbols, the three lowest primary bonuses of 30, 50, and 70 credits per active payline are unavailable to the player. In other words, each SIDEKICK symbol in the start-bonus outcome successively removes a primary bonus from the hierarchy of primary bonuses that can be won by the player, starting with the lowest primary bonus in the pay table.

Accordingly, the probability of winning each available primary bonus, including the highest primary bonus of 250 credits per active payline, successively increases for each SIDEKICK symbol in the start-bonus outcome. Specifically, if the start-bonus outcome includes no SIDEKICK symbols, the player has a 1 in 8 probability of winning each of the primary bonuses of 250, 200, 150, 100, 80, 70, 50, and 30 credits per active payline; if the start-bonus outcome includes one SIDEKICK symbol, the player has a 1 in 7 probability of winning each of the primary bonuses of 250, 200, 150, 100, 80, 70, and 50 credits per active payline (30 credits not available); if the start-bonus outcome includes two SIDEKICK symbols, the player has a 1 in 6 probability of winning each of the primary bonuses of 250, 200, 150, 100, 80, and 70 credits per active payline (30 and 50 credits not available); and, finally, if the start-bonus outcome includes three SIDEKICK symbols, the player has a 1 in 5 probability of winning each of the primary bonuses of 250, 200, 150, 100, and 80 credits per active payline (30, 50, and 70 credits not available).

Referring now to FIG. 11, there is shown a multiplier table for the bonus payout multiplier for finding the hiding place of the guilty character in the hideout shown in the display screen capture in FIG. 9. The multiplier is based on the number of selections required to find the hiding place of the guilty character. The fewer the number of selections it takes the player to find the hiding place, the greater the bonus payout multiplier. If a player finds the hiding place with his or her first selection, the total bonus payout to that point in the game is multiplied by 8; if the player finds the hiding place with his or her second selection, the total bonus payout is multiplied by 5; if the player finds the hiding place with his or her third selection, the total bonus payout is multiplied by 4; and so on.

In the illustrated embodiment, the number of selectable hiding places is not affected by the number of SIDEKICK symbols appearing in the start-bonus outcome. Therefore, the player has a 1 in 5 probability of winning each of the multipliers of ×8, ×5, ×4, ×3, and ×2, regardless of the number of SIDEKICK symbols appearing in the start-bonus outcome.

In an alternative embodiment, the number of selectable hiding places is reduced by one for each SIDEKICK symbol appearing in the start-bonus outcome and, therefore, the number of available multipliers is reduced by one, starting from the lowest multiplier appearing in the multiplier table, for each SIDEKICK symbol appearing in the start-bonus outcome. Accordingly, the probability of winning each available multiplier, including the highest multiplier of ×8, successively increases for each SIDEKICK symbol in the start-bonus outcome.

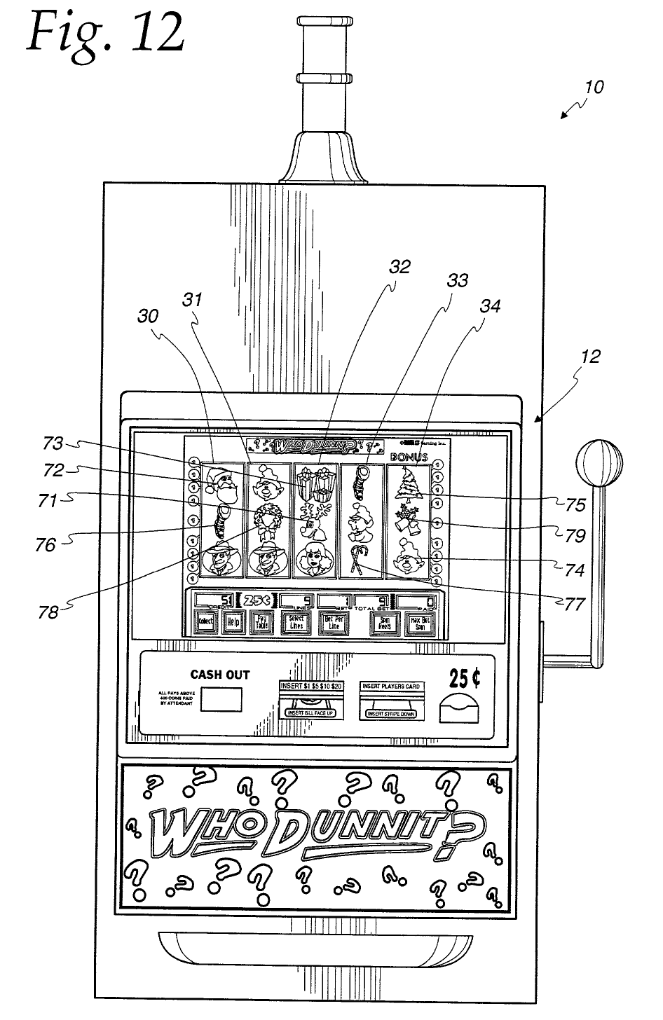

FIG. 12 illustrates the gaming machine 10 having a video display 12 where the five simulated reels 30-34 now include symbols 71-79 having a Christmas theme, such as a reindeer 71, Santa's face 72, presents 73, an elf 74, the Christmas tree 75, a stocking 76, a pair of candy canes 77, a Christmas wreath 78, and holly with bells 79. These symbols 71-79 of the Christmas motif replace the symbols shown in FIG. 3 when a predetermined time is encountered, usually a time just before Christmas.

The predetermined time is determined by the CPU 16 (FIG. 2). Typically, the CPU 16 has an internal clock that can be used to determine the real time of the gaming machine 10, or the CPU 16 may receive signals from an external clock. The CPU 16 then downloads data from the system memory 20 (FIG. 2) that corresponds to the Christmas symbols 71-79 that will be displayed on the video display 12 when the predetermined time is encountered. Accordingly, the Christmas motif is displayed on the reels 30-34 at a known and predetermined time.

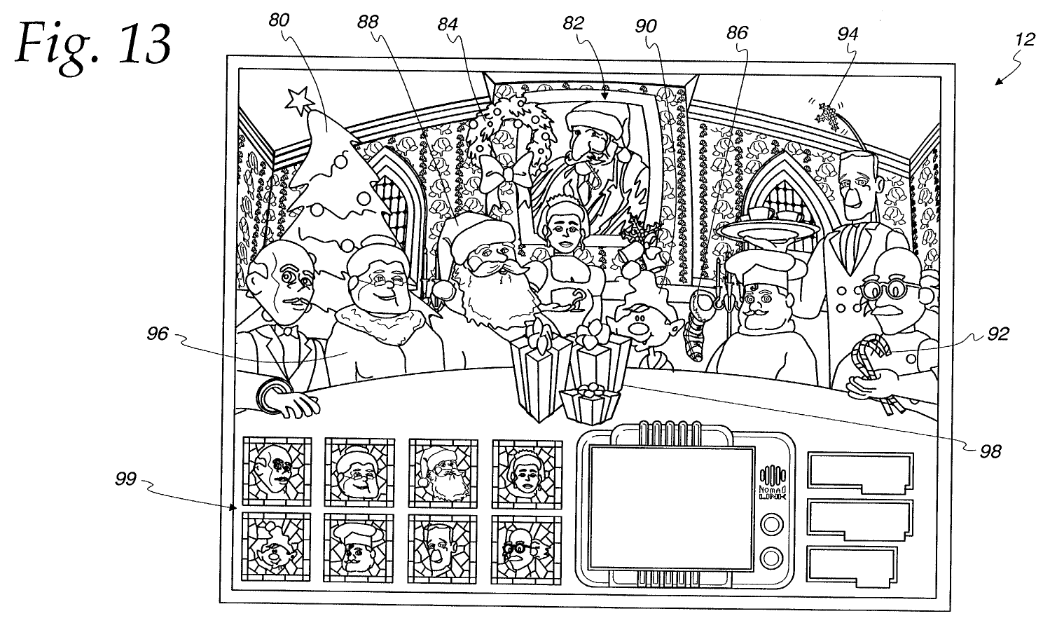

FIG. 13 illustrates the display 12 in which the player of the gaming machine 10 has engaged in a bonus game similar to FIG. 5. Unlike the bonus game display of FIG. 5, however, the bonus game of FIG. 13 is of a Christmas holiday theme or motif For example, a Christmas tree 80 has now been placed in the back of the room. The picture of the distinguished gentleman in the center of the room has been replaced by a Christmas theme gentleman 82 wearing a Santa hat and chewing a candy cane. Further, there is a Christmas wreath 84 in the middle of the room and a stocking 86 hanging on the wall. All of these items are, of course, background features to the substantive display elements that the player selects (via a touch screen or keyboard) to determine whether he or she will be receiving a bonus game payout. In other words, these Christmas motif visual elements 80, 82, 84, and 86 are independent of whether a player will receive a bonus payout. Other types of non-selectable visual elements are displayed while no player is playing the gaming machine. This may include the characters from the bonus game.

In addition, the visual element features of the bonus game that are selected by the player with the hope of receiving a bonus payout have also changed. For example (and referring also to FIG. 5), the Shady Lawyer has now been replaced by Santa Claus 88. The Little Girl has been replaced by an Elf 90. The Professor is now holding a handful of candy canes 92 and the Butler now has a holly leaf 94 hanging from his head. Further, the Old Maid is now dressed in holiday garb 96 and appears quite joyous. In addition, the items of value that were formerly in the center of the table have now been replaced by Christmas presents 98. If the bonus game includes a menu panel that is selectable by the player, then it may be a Christmas theme menu panel 99. Thus, the gaming machine 10 may change visual elements that are associated with or unassociated with the outcome of the game.

The data that is needed to modify these visual elements is stored in system memory 20 (FIG. 2), just as the data for FIG. 5 is also stored in system memory 20 (FIG. 2). When the real time of the gaming machine 10 reaches a predetermined time, such as December 10, the CPU 16 (FIG. 2) then stops downloading data corresponding to the visual elements of FIG. 5 and begins to download data from the system memory 20 (FIG. 2) corresponding to the visual elements of FIG. 13. The data may be for “still” video images or may be animated so that one or more of the images moves. It should also be noted that the data for specific events can also be externally downloaded from a casino gaming machine system controller, or possibly the internet, instead of being downloaded from the internal memory 20 of the gaming machine.

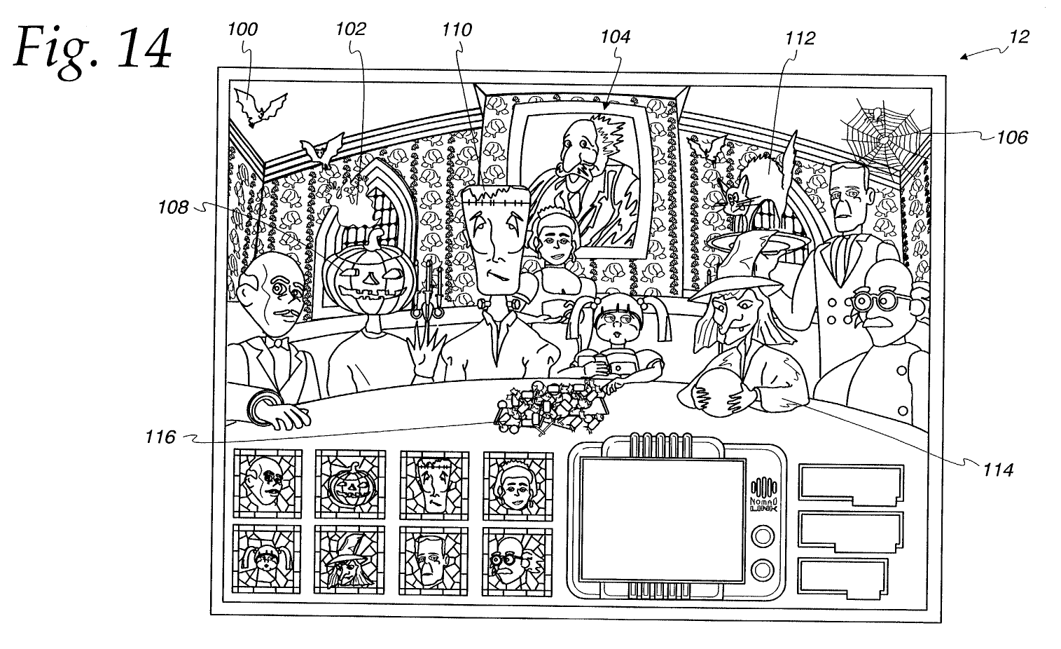

In FIG. 14, the video display 12 illustrates the cast of characters in FIG. 5 in a Halloween motif Here, there are bats 100 and a ghost 102 in the background. The distinguished gentleman in the picture has now been replaced by a frightened gentleman 104 and a spider web 106 is at the top right corner of the picture. Additionally, the Old Maid has been changed to a Pumpkin Head 108. The Shady Lawyer has been replaced by Frankenstein 110, the Butler is now serving a cat 112 on his plate, and the Italian Chef has been replaced by a Witch 114 gazing into a crystal ball. Additionally, the items of value at the center of the table in FIG. 5 have been replaced by trick-or-treat candy 116.

Like the data for the visual elements and animation for the Christmas theme of FIG. 14, the data that is needed to develop the Halloween visual elements and animation are stored in system memory 20. When the real time reaches a predetermined time, such as October 20 (or simply the day October 31), then the CPU 16 (FIG. 2) begins to download the data that will produce the Halloween visual elements of FIG. 14 instead of the data that produces FIG. 5.

While the illustrated embodiments of the present invention have included Christmas and Halloween motifs, different motifs for other commonly known societal events and holidays can also be stored in the memory. For example, the holidays of Valentine's Day, St. Patrick's Day, Mardi Gras, Easter, the 4^{th} of July, Thanksgiving, New Year's Eve, and New Year's Day can also have associated visual elements, the data sets for which are stored in the system memory 20 (FIG. 2). When the CPU 16 (FIG. 2) determines from the internal or external clock that the real time is one of these holidays or a range of days before and after one of these holidays, the CPU 16 (FIG. 2) then downloads the associated data set from the system memory 20 (FIG. 2).

Consequently, because the visual effects and aesthetics of the game are constantly changing, the player appeal of the gaming machine time is increased.

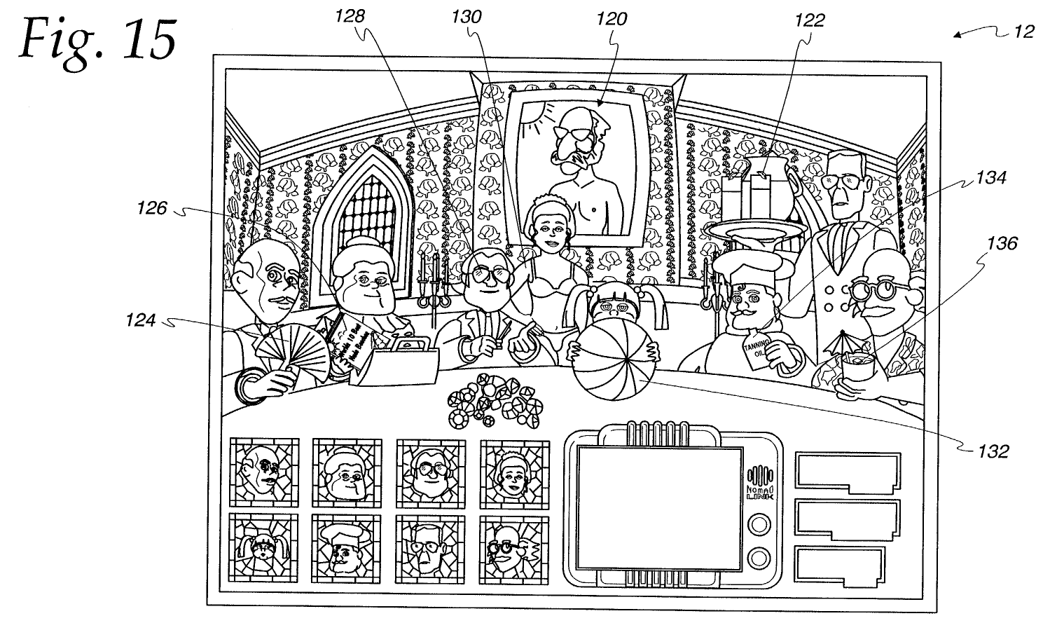

The gaming machine 10 can also change its visual elements based on seasonal conditions, as opposed to holidays or other societal events. For example, in FIG. 15, the theme has now shifted to a summer theme. The distinguished gentleman in the picture in FIG. 5 is now a bare-chested, older man 120 donning sunglasses. The Butler is also wearing sunglasses and is now bringing a tray full of iced tea to the remainder of the characters. The Accountant is holding a fan 124, the Old Maid is holding a beach book 126, and the Shady Lawyer 64 is wearing a pair of shades. Further, the French Maid is now wearing a bikini 130, the Little Girl is holding a beach ball 132, the Italian Chef is holding tanning oil 134, and the Professor is drinking a fruity cocktail 136 and wearing a Hawaiian shirt. The seasonal summer theme of FIG. 15 can been downloaded by the CPU 16 (FIG. 2) from the system memory 20 (FIG. 2) during certain times of the summer or all summer. Further, this summer motif may be displayed during selected days during the summer, such Memorial Day weekend or Labor Day weekend. Similarly, a spring, fall, or winter theme can be established, as well. Considering all the various holiday and seasonal themes, it is possible to have the visual motif change from theme to theme without playing the same theme twice in one year.

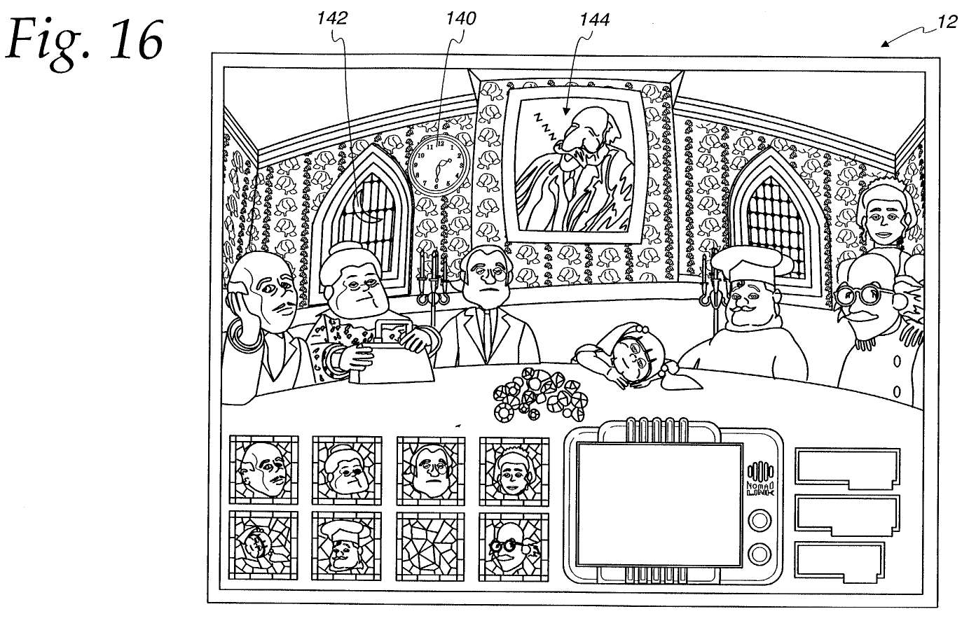

FIG. 16 illustrates a different type of motif that occurs when the predetermined time is at a certain time of the day. For example, when the time is late at night, the expressions of the characters can shift to ones which show exhaustion or listlessness. Additionally, the background elements can change such that a clock 140 on the wall illustrates the real time, for example, 2:30 AM. Further, some of the characters may change their activities, such as the Little Girl putting her head down on the table and the French Maid now giving the Professor a rubdown on his shoulders. A moon 142 can appear in one window and move across that window as time progresses (or even move to the window on the other side of the room at a certain time as well). Very late in the evening (e.g., 5:00 AM), the sun can begin to rise through the windows and birds can begin to chirp. Additionally, the distinguished gentleman 144 in the picture at the side of the room can suddenly close his eyes and begin to snore, as exhibited by the zzz's exiting his mouth.

FIGS. 12-16 have been described as having an alteration of the visual elements of the gaming machine 10 to provide player appeal. Alternatively, the gaming machine 10 can have only audio elements which occur at the predetermined time. For example, during the Christmas season, one or more of the characters in FIG. 5 may state something like: “[w]hy would I steal any of these precious items when this is Christmas, the season of giving?” or “I'm having a little problem funding Christmas this year.” Alternatively, during Halloween, the Little Girl may say “I'm feeling a little scared tonight. It seems spooky in here.” Similar audio elements can be stored in the memory device 20 (FIG. 2) for each of the common societal holidays or events throughout the year and broadcasted through audio speakers while the standard visual motif of FIG. 5 remains unchanged. The audio elements may be indicative of seasons or the time of a certain day (i.e., a bell sounding at the top of each hour or birds chirping in the morning). The audio elements may be associated with an outcome.

In a further embodiment, the visual elements can be displayed and the audio elements broadcasted in unison at a predetermined time. In other words, the player is visualizing various types of holiday themes at certain times of the year while also listening to certain audio elements associated with that holiday as well. These audio elements may be as simple as music associated with that societal event or holiday or the phrases and statements from various characters within the game, similar to those mentioned in the previous paragraph.

In yet a further alternative embodiment, the gaming machine can display or broadcast trivia on a certain day of the year or provide audio trivia elements on a certain day of the year. For example, on September 27 of any year, the gaming machine 10 may display or broadcast certain pieces of trivia, such as “[o]n Sep. 27, 1998, Mark McGwire of the St. Louis Cardinals hit home run numbers 69 and 70 to set the major league baseball home run record.” Or on October 18 of any year, the gaming machine 10 may display or broadcast “[o]n Oct. 18, 1924, Harold ‘Red’ Grange, also known as the ‘Galloping Ghost,’ scored five touchdowns and passed for another for the University of Illinois as Illinois defeated previously undefeated Michigan 39-14, in what many believe to be the greatest offensive display in college gridiron history.”

Several pieces of trivia may be provided for each given day of the year and may be displayed via visual elements or broadcast via audio elements between games within the gaming machine 10 or after a player has achieved a certain positive outcome. For example, after a positive outcome is achieved on September 27 of any year, the gaming machine 10 may query the player “[a]re you as happy today as Mark McGwire was on Sep. 27, 1998 when he hit home run numbers 69 and 70 to set the major league baseball home run record?” This is an example of an audio element or visual element that is associated with a particular outcome. In yet a further alternative, the trivia facts displayed on the machine for a certain date may progressively tell a story, for example, the hourly occurrences during the invasion of Normandy from World War II. As such, if the player remains on the gaming machine 10, the player may receive five or ten different chronologically timed facts about the invasion of Normandy and how it progressed on that date in 1944.

In another alternative, the gaming machine payout structure can be modified as a function of the predetermined time. The changing of the payout structure can occur by itself or in combination with changing the visual or audio elements of the gaming machine 10. The payout structure has a certain payback percentage that is a function of the amounts of possible paybacks and the likelihood of the occurrence for each of the paybacks. Put simply, the payback percentage is defined as the average percent of each wager that is returned to players. Thus, a first payout structure may have a lower payback amount that occurs more frequently. A second payout structure would have a higher payback amount that occurs less frequently. Yet, the first and second payout structures would have the same payback percentage. In response to the occurrence of a predetermined time, the payout structure can change from a standard payout structure to a modified payout structure. For example, between midnight and 1:00AM, the payout structure may be set such that the payouts are more frequent, i.e., paybacks are not as high, but they occur more frequently. As another example, on St. Patrick's Day, the visual and audio elements may include Leprechauns speaking and the payout structure may be altered to provide lower payouts, but more frequently.

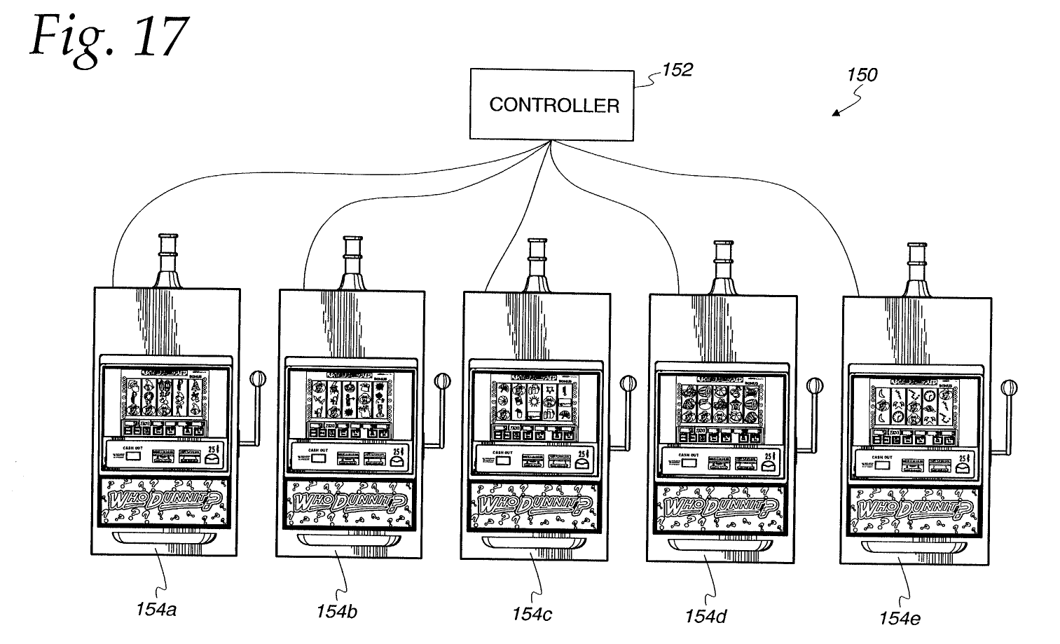

Referring now to FIG. 17, a gaming machine system architecture 150 is illustrated that includes a controller 152 that is linked to a plurality of gaming machines 154a-154e. The system architecture 150 is useful for determining which type of visual elements, audio elements, or other types of player appeal features are the favorite among players. In the system architecture 150, the wager inputs for each of the plurality of gaming machines 154a-154e are monitored by the controller 152. The controller 152 may intermittently download information on the wager inputs at selected times or continuously download information for real time updates. A correlation exists between the favorite visual elements, audio elements, or other player appeal features and the total amount of wager inputs for the associated machine on which they are displayed and/or broadcasted. When the controller 152 determines that a particular player appeal feature is the favorite of players, it then takes the necessary steps to inform a particular one of the gaming machines 154a-154e, which is not displaying or broadcasting the favorite visual and/or audio elements, to begin playing the favorite visual and/or audio element. In other words, the amount of wager input to each machine is a feedback mechanism by which the controller 152 determines which of the visual elements, audio elements, and/or other player appeal features is the favorite, thereby causing that favorite to be displayed and/or broadcasted more frequently on other machines 154a-154e. For example, the favorite visual element or audio element may be displayed for more than 75% of any day or 75% of any week.

In addition to the feedback mechanism described above with reference to FIG. 17, the internal controller (e.g., CPU 16 in FIG. 2) of one particular gaming machine 10 monitors the wager inputs for that machine while different visual elements are being displayed, audio elements are being broadcasted, and other player appeal features are being displayed/broadcasted so that the controller internally determines which of the features are the most appealing to the players. Once the favorite of the players is determined, the internal controller for the gaming machine 10 begins to play that player appeal feature more frequently. Because the amount of wager inputs is also a function of the number of people in the casino, which is a function of the day and the time of the day, the controller of the internal machine or the controller 152 of the system architecture 150 of FIG. 17 may monitor wager inputs over a longer period of time, such as a week, in order to determine which of the player appeal features is the favorite.

Further, the gaming machine 10 or the system architecture 150 of FIG. 17 may determine the types of video elements and audio elements that are the favorite at certain times of the day or on certain days of the week. This is due to the demographics of individuals entering the casino on certain days and at certain hours of the evening. Accordingly, knowing that a demographic group is most prevalent on Friday nights and Saturday nights, the gaming machine 10 and the system architecture 150 of FIG. 17 may act to determine the favorites on Friday nights and Saturday nights and display those favorites more on those nights, than on other nights. Alternatively, a second demographic group may be more prevalent during the weekdays from 8:00 AM until 4:00 PM. Thus, the gaming machine 10 and the system architecture 150 of FIG. 17 may act to determine the favorites for this second demographic group and display those favorites at those hours.

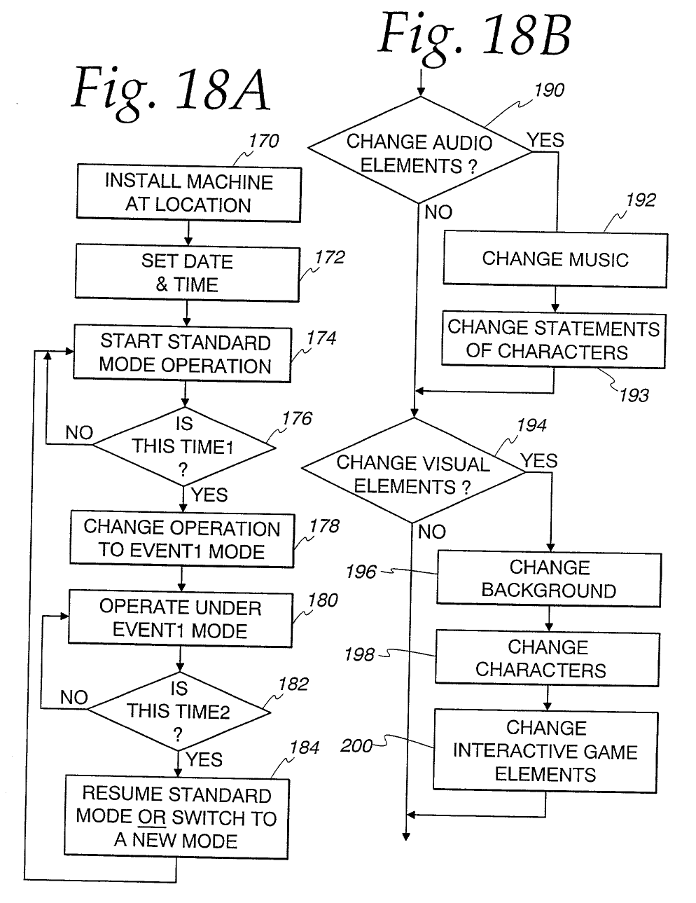

Referring now to FIG. 18A, the algorithm for establishing the use of the gaming machine 10 having a modified array of visual and/or audio elements is disclosed. First, at step 170, the machine is installed at a certain location, likely within a casino. Next, at step 172, the data for the time and date on the machine is established so that it is concurrent with real time. This is typically accomplished through the setting of the internal clock of the CPU 16 (FIG. 2) or an external clock that the CPU 16 (FIG. 2) monitors.

At step 174, the gaming machine 10 begins standard operation, whereby the standard visual elements for the gaming machine 10 are displayed (e.g., those associated with the operation pursuant to FIGS. 1-11). In the next step, step 176, the CPU 16 (FIG. 2) checks to see if the time is “time1.” If the time is not “time1,” the machine continues to operate in a standard mode of operation by returning to step 174. If the real time monitored by the CPU 16 (FIG. 2) is “time1,” then the gaming machine begins a change of operation illustrated by step 178. In a preferred embodiment, the gaming machine 10 waits until the current game being played by a player at “time1” is finished before altering the visual and audio elements. At step 180, the gaming machine 10 begins to display the modified set of visual elements or broadcast the modified set of audio elements associated with “time1,” which in real time is a certain time of day, season of the year, or commonly known societal holiday or event, “event1.” That mode of operation continues until the real time is “time2,” as shown in step 182.

When the real time is “time2,” as determined at step 182, then the machine resumes the standard mode or can, alternatively, switch to a new mode of operation as shown in step 184. As such, the gaming machine 10 is then displaying these visual and/or audio elements associated with “event1” only between the real times corresponding to “time1” and “time2.”

It should be noted that in step 184, when one switches to “a new mode of operation,” video and/or audio elements are displayed and broadcast that are different than the initial mode of operation at step 174. That new mode of operation may continue until “time1” of the next day, week, month, or year is again achieved. Of course, the algorithm can be modified to have steps 176 and 182 have several dates (“time3,” “time1,” “time1,” etc., for step 176, and “time1,” “time1,” “time1,” etc., for step 182) so that numerous changes can be made as a function of real time that provide a vast array of different audio and/or visual elements, thereby increasing player appeal.

FIG. 18B provides one example of the general analysis that may occur under step 178. In step 190, the gaming machine 10 determines whether the new mode of operation associated with “event1” requires a change of the audio or audio elements. If it does, then the machine may change the music 192 and the character statements 193 (e.g., statements from the Shady Lawyer, Santa Claus, Old Maid, Professor, etc.). If the answer to step 190 is that the “event1” mode of operation does not require the changing of the audio or audio elements, then the machine proceeds to step 194, whereby the visual elements may be changed. If the visual elements require changing, then the background may change at step 196, the characters may change at step 198, and the interactive game elements may change at step 200. An example of the interactive game elements that are changed at step 200 is the simulated reels illustrated in FIGS. 1, 3, and 11, or the menu panels 67 (FIG. 7) and 99 (FIG. 13). Of course, the characters may also be considered interactive game elements.

Alternatively, the mode of operation of “event1” may only change the audio elements in steps 192 and 193, but not require changes to the visual elements at step 194. In the case of a negative response at step 194, the visual elements do not change.

The algorithm of FIG. 18B is general. Certain events may require specific changes not illustrated in FIG. 18B. That is, the types of changes made to the video and audio elements are a function of the event associated with the real time. Thus, the data associated with various times such as “time1,” “time3,” “time5,” etc., include instructions as to whether the audio elements are changed, whether the video elements are changed, and instructions on exactly how the audio and video elements are to be changed.

In a further embodiment, the gaming machine 10 acts to change the frequency at which a player encounters the bonus game while playing the basic game. The basic game includes a plurality of possible randomly-selected basic outcomes. In addition to the basic game generating a basic game payout in response to winning ones of the plurality of basic outcomes, at least one of the plurality of possible basic outcomes is a start-bonus outcome that triggers a bonus game feature that may generate a further payout bonus for the player. The start-bonus outcome has an average hit frequency, which is defined as how often the start-bonus outcome occurs on average relative to the plurality of possible basic outcomes. In this embodiment, the average hit frequency of the start-bonus outcome is automatically adjusted by the CPU 16 based on programmed criteria.

As in the previous embodiments, the gaming machine 10 may change the average hit frequency as a function of time. For example, the average hit frequency of the start-bonus outcome may be automatically increased by the CPU 16 at a predetermined time. The predetermined time is a certain time of day, time of month, time of year, or even a particular year. Programmed criteria other than time-based criteria are available, as well.

The gaming machine 10 has a payback percentage defined as the average percent of each wager that is returned to players in basic and bonus game payouts. The payback percentage of the gaming machine 10 is kept substantially the same by the CPU 16 even though the average hit frequency of the start-bonus outcome is automatically adjusted. Thus, the average value of the bonus generated by the bonus feature is adjusted by the CPU 16 to compensate for the adjustments to the average hit frequency of the start-bonus outcome. In particular, the average value of the bonus is decreased by the CPU 16 as the average hit frequency of the start-bonus outcome is increased by the CPU 16 and vice-versa.

While the present invention has been described with reference to one or more particular embodiments, those skilled in the art will recognize that many changes may be made thereto without departing from the spirit and scope of the present invention. For example, the basic game need not comprise a spinning reel slot machine game as illustrated in FIG. 1, but may comprise virtually any type of game of chance or skill or combination of games having outcomes (e.g., start-bonus outcomes) that trigger play of a bonus game on the video display 12. For example, the basic game may comprise a video poker or video blackjack game and, thus, altering of the poker or blackjack game may be to provide a holiday or seasonal theme. For example, the face cards of the deck may change to include a queen holding a candy cane or a king wearing a Santa hat. Other non-selectable background visual features (and audio features) can also change to reflect the holiday or season. The basic game itself may be implemented on the video display 12 or a separate video display. In embodiments where both the basic and bonus games are implemented in video, each game may be shown on the same video display 12. Each of these embodiments and obvious variations thereof is contemplated as falling within the spirit and scope of the claimed invention, which is set forth in the following claims.

What is claimed is:

1. A gaming machine having a processor monitoring real time, comprising:
a basic game controlled by said processor in response to a wager amount and including basic game visual elements, said basic game having a plurality of start-bonus outcomes;
a bonus game controlled by said processor and activated by the occurrence of one of said plurality of start-bonus outcomes, said bonus game including bonus game visual elements displayed while said bonus game is activated; and
a memory device coupled to said processor and storing at least two basic game data sets for producing at least two different types of said basic game visual elements and at least two bonus game data sets for producing at least two different types of said bonus game visual elements, said processor selecting one of said at least two basic game data sets and one of said at least two bonus game data sets in response to said real time being a predetermined time.

2. The gaming machine of claim 1, wherein said basic game includes a simulated spinning reel display showing a plurality of symbols, said basic game visual elements including at least some of said plurality of symbols.

3. The gaming machine of claim 1, wherein said bonus game visual elements include a plurality of non-selectable symbols that are independent of a bonus payout from said bonus game.

4. The gaming machine of claim 3, wherein said plurality of non-selectable symbols are background visual elements.

5. The gaming machine of claim 1, wherein said bonus game visual elements include a plurality of selectable symbols, said bonus game including a chance for a bonus payout dependent on said plurality of selectable symbols.

6. The gaming machine of claim 5, wherein said plurality of selectable symbols are selected by a game player on a keyboard.

7. The gaming machine of claim 5, wherein said plurality of selectable symbols are selected by said game player via a touch screen.

8. The gaming machine of claim 1, wherein said predetermined time is at least one day in a calendar year.

9. The gaming machine of claim 8, wherein said at least one day is a holiday.

10. The gaming machine of claim 9, wherein said holiday is selected from a group consisting of Valentine's Day, St. Patrick's Day, Mardi Gras, Easter, the 4^{th} of July, Halloween, Thanksgiving, Christmas, New Year's Eve, and New Year's Day.

11. The gaming machine of claim 8, wherein said at least one day is a holiday and at least one day before and after said holiday.

12. The gaming machine of claim 8, wherein one of said at least two different types of said bonus game or basic game visual elements includes animated characters having visual indicia of a holiday motif.

13. The gaming machine of claim 12, wherein said characters are animated so as to provide movement.

14. The gaming machine of claim 1, wherein said predetermined time is at least one minute within one day.

15. The gaming machine of claim 14, wherein said at least one minute includes a plurality of minutes during the nighttime, and one of said at least two different types of said bonus game or basic game visual elements includes characters appearing to be physically exhausted.

16. The gaming machine of claim 15, wherein said characters are animated so as to provide movement.

17. The gaming machine of claim 1, wherein said predetermined time is a particular day, and one of said at least two different types of said bonus game or basic game visual elements includes a trivia fact associated with said particular day from a previous year.

18. The gaming machine of claim 17, wherein said predetermined time is a plurality of times within said particular day, and a different trivia fact is displayed at each of said plurality of times.

19. The gaming machine of claim 1, wherein said processor selects one of said at least two basic game data sets and one of said at least two bonus game data sets for display after a player has finished a gaming session if said predetermined time occurs during said gaming session.

20. The gaming machine of claim 1, wherein said bonus game visual elements are also displayed while said bonus game is inactive.

21. The gaming machine of claim 1, wherein said predetermined time is determined, in part, due to a clock that is internal to said processor.

22. The gaming machine of claim 1, wherein said memory device further includes at least two audio data sets for producing at least two different types of audio elements, said processor selecting one of said at least two audio data sets in response to the occurrence of said predetermined time that is monitored by said processor.

23. The gaming machine of claim 1, wherein said predetermined time is a day of the calendar year, and one of said at least two different types of said bonus game visual elements includes visual features representative of a season, wherein said season is selected from the group consisting of spring, summer, fall, and winter.

24. The gaming machine of claim 1, further including a display for displaying said visual elements, said display being selected from the group consisting of dot matrix, CRT, LED, LCD, and electro-luminescent displays.

25. The gaming machine of claim 1, wherein said gaming machine is selected from the group consisting of a stand-up slot machine, a sit-down slot machine, a video blackjack machine, and a video poker machine.

26. A gaming machine, comprising:
a processor for randomly selecting one of a plurality of outcomes of said gaming machine in response to a wager amount, said processor monitoring time signals from a clock;
a display for displaying visual elements; and
a memory device coupled to said processor and storing at least two data sets for producing at least two different types of said visual elements, said processor selecting one of said at least two data sets in response to said processor monitoring a time signal corresponding to a predetermined time.

27. The gaming machine of claim 26, wherein said predetermined time is a particular day, and said visual elements include a trivia fact associated with said particular day from a previous year.

28. The gaming machine of claim 27, wherein said predetermined time is a plurality of times within said particular day, and a different trivia fact is displayed at each of said plurality of times.

29. The gaming machine of claim 26, wherein said display is selected from the group consisting of dot matrix, CRT, LED, LCD, and electro-luminescent displays.

30. The gaming machine of claim 26, wherein one of said at least two different types of visual elements is a standard motif, and another of said at least two different types of visual elements is a holiday motif.

31. The gaming machine of claim 26, further including an audio speaker for broadcasting audio elements, said memory device storing at least two audio data sets for producing at least two different types of audio elements, said processor selecting one of said at least two audio data sets in response to said processor monitoring said time signal.

32. The gaming machine of claim 26, wherein said visual elements are associated with said plurality of outcomes.

33. The gaming machine of claim 26, wherein said visual elements are unassociated with said plurality of outcomes.

34. The gaming machine of claim 26, wherein said predetermined time is at least one day in a calendar year, said at least one day being a holiday.

35. The gaming machine of claim 34, wherein said holiday is selected from a group consisting of Valentine's Day, St. Patrick's Day, Mardi Gras, Easter, the 4^{th} of July, Halloween, Thanksgiving, Christmas, New Year's Eve, and New Year's Day.

36. The gaming machine of claim 34, wherein said at least one day further includes at least one day before and after said holiday.

37. The gaming machine of claim 26, wherein said visual elements are characters.

38. The gaming machine of claim 37, wherein said characters are animated.

39. The gaming machine of claim 26, wherein said clock is internal to said processor.

40. A gaming machine, comprising:
a processor for randomly selecting one of a plurality of outcomes of said gaming machine in response to a wager amount, said processor monitoring time signals from a clock;
an audio speaker for broadcasting audio elements; and
a memory device coupled to said processor and storing at least two data sets for producing at least two different types of said audio elements, said processor selecting one of said at least two data sets in response to said processor monitoring a time signal corresponding to a predetermined time.

41. The gaming machine of claim 40, wherein said audio elements are unassociated with said plurality of outcomes.

42. The gaming machine of claim 40, wherein said audio elements are associated with said plurality of outcomes.

43. The gaming machine of claim 40, wherein said predetermined time is at least one day in a calendar year, said at least one day being a holiday.

44. The gaming machine of claim 43, wherein said holiday is selected from a group consisting of Valentine's Day, St. Patrick's Day, Mardi Gras, Easter, the 4^{th} of July, Halloween, Thanksgiving, Christmas, New Year's Eve, and New Year's Day.

45. The gaming machine of claim 43, wherein said a t least one day further includes at least one day before and after said holiday.

46. A method of operating a gaming machine, comprising:
displaying a plurality of standard visual elements;
monitoring real time; and
displaying a plurality of modified visual elements in response to said real time being a predetermined time, said plurality of modified visual elements having a theme that is indicative of a commonly known societal event that is associated with said predetermined time.

47. The method of claim 46, wherein said step of monitoring real time includes monitoring a clock that is external to a processor in said gaming machine.

48. The method of claim 46, wherein said step of monitoring real time includes monitoring a clock that is internal to a processor in said gaming machine.

49. The method of claim 46, wherein both of said steps of displaying include the step of downloading data corresponding to said visual elements from a memory device.

50. The method of claim 49, wherein said steps of downloading include accessing a memory device that is external to said gaming machine.

51. The method of claim 49, wherein said steps of downloading include accessing a memory device that is internal to said gaming machine.

52. The method of claim 46, wherein said commonly known societal event is a holiday.

53. The method of claim 46, wherein said commonly known societal event is selected from a group consisting of Valentine's Day, St. Patrick's Day, Mardi Gras, Easter, the 4of July, Halloween, Thanksgiving, Christmas, New Year's Eve, and New Year's Day.

54. The method of claim 46, wherein said plurality of modified visual elements include visual elements that are selectable by said player so as to result in one of a plurality of random outcomes.

55. The method of claim 46, wherein said plurality of modified visual elements include visual elements that are non-selectable by said player.

56. A method of operating a gaming machine, comprising:
broadcasting a plurality of standard audio elements while said gaming machine is operating;
monitoring real time; and
broadcasting a plurality of modified audio elements in response to said real time being a predetermined time, said plurality of modified audio elements having a theme that is indicative of a commonly known societal event that is associated with said predetermined time.

57. The method of claim 56, wherein both of said steps of broadcasting include the step of downloading data corresponding to said audio elements from a memory device.

58. The method of claim 57, wherein said step of downloading includes accessing a memory device that is external to said gaming machine.

59. The method of claim 57, wherein said steps of downloading includes accessing a memory device that is internal to said gaming machine.

60. A method of operating a gaming machine, comprising:
providing a standard payout structure having a payback percentage;
monitoring real time; and
replacing, in response to said real time being a predetermined time, said standard payout structure with a modified payout structure, said modified payout structure having a payback percentage that is the same as said standard payout structure.

61. The method of claim 60, wherein said predetermined time is a certain time period within a day.

62. The method of claim 60, wherein said predetermined time is at least one day within a year.

63. The method of claim 60, wherein said gaming machine has certain visual elements, said visual elements changing at said predetermined time.

64. A method of operating a gaming machine, comprising:
monitoring real time; and
replacing, in response to said real time being a predetermined time, a plurality of first payouts having a first payout frequency with a plurality of second payouts having a second payout frequency, without altering the payback percentage.

65. The method of claim 64, wherein said gaming machine has certain visual elements, and further including the step of changing said visual elements at said predetermined time.

66. The method of claim 64, wherein said step of monitoring real time includes monitoring a clock that is external to a processor in said gaming machine.

67. A gaming machine, comprising:
a processor for randomly selecting one of a plurality of outcomes of said gaming machine in response to a wager amount, said processor monitoring time signals from a clock; and
a memory device for storing at least first and second payout structures each of which dictates said plurality of outcomes, said first payout structure having higher payout amounts and a lower payout frequency than said second payout structure, said processor downloading said first payout structure in response to said processor monitoring a time signal corresponding to a first predetermined time, said processor downloading said second payout structure in response to said processor monitoring a time signal corresponding to a second predetermined time.

68. The machine of claim 67, wherein said clock is external to said gaming machine.

69. The machine of claim 67, wherein said predetermined time is a certain time period within a day.

70. A method of enhancing the entertainment value of a gaming machine under control of a processor, comprising:
storing a plurality of visual element data sets in a memory device to be accessed by said processor, each of said plurality of visual element data sets corresponding to a different visual element motif,
displaying each of said visual element motifs for a selected period of time on said gaming machine;
determining which one of said visual element motifs is the favorite by monitoring, with said controller, wager inputs while each of said visual element motifs is activated; and
displaying said favorite visual element motif for a larger portion of the total operating time.

71. The method of claim 70, wherein said selected period of time is one day, and said step of monitoring wager inputs for each of said visual element motifs occurs for one day.

72. The method of claim 70, wherein said larger portion of the total operating time is greater than 75% of any day.

73. The method of claim 70, wherein said larger portion of the total operating time is greater than 75% of any week.

74. The method of claim 70, wherein said different visual element motifs being monitored are all of a holiday motif.

75. The method of claim 70, wherein said selected period of time is one week, and said step of monitoring wager inputs for each of said visual element motifs occurs for one week.

76. The method of claim 70, further including a step of sending a signal to an external system informing said external system of said favorite visual element motif.

77. The method of claim 70, wherein said step of determining includes receiving a signal from an external system instructing said gaming machine of said favorite visual element motif.

78. The method of claim 70, wherein said step of determining includes a first favorite visual element motif for a first time of the day and a second favorite visual element motif for a second time of the day.

79. The method of claim 70, wherein said step of determining includes a first favorite visual element motif for a first day of the week and a second favorite visual element motif for a second day of the week.

80. A method of enhancing the entertainment value of a plurality of gaming machines, each of which is linked to a common controller, comprising:
storing a plurality of visual element data sets in a memory device, each of said plurality of visual element data sets corresponding to a certain visual element motif;
displaying different visual element motifs on different ones of said plurality of gaming machines;
determining which one of said visual element motifs is the favorite by monitoring, with said common controller, wager inputs from each of said plurality of gaming machines; and
displaying said favorite visual element motif on a proportionally larger number of said plurality of gaming machines.

81. The method of claim 80, wherein said step of determining which one of said visual element motifs is the favorite includes determining a first favorite visual element motif for a first time of the day and a second favorite visual element motif for a second time of the day.

82. The method of claim 80, wherein said step of determining which one of said visual element motifs is the favorite includes determining a first favorite visual element motif for a first day of the week and a second favorite visual element motif for a second day of the week.

83. The method of claim 80, wherein said memory device is an external memory accessible via said common controller, and said step of displaying includes downloading a selected data set from said external memory.

84. The method of claim 80, wherein said step of storing includes the steps of storing said plurality of visual element data sets in a memory device located within each of said gaming machines.

85. The method of claim 80, wherein said step of monitoring with said common controller includes intermittent downloading of data regarding said favorite visual element motif.

86. The method of claim 80, wherein said step of monitoring with said common controller includes continuous downloading of data regarding said favorite visual element motif.

87. A gaming machine controlled by a processor in response to a wager, comprising:
a basic game including a plurality of possible randomly-selected basic outcomes, the plurality of possible basic outcomes including a start-bonus outcome, the basic game generating a basic game payout in response to winning ones of the basic outcomes, the start-bonus outcome having an average hit frequency defined as how often the start-bonus outcome occurs on average relative to the plurality of possible basic outcomes, the average hit frequency of the start-bonus outcome being automatically adjusted by the processor based on programmed criteria; and
a bonus feature triggered by the start-bonus outcome and generating a bonus.

88. The gaming machine of claim 87, wherein the basic game includes a plurality of symbol-bearing reels rotated and stopped to randomly place symbols on the reels in visual association with a viewable display area.

89. The gaming machine of claim 87, wherein the programmed criteria is time-based.

90. The gaming machine of claim 89, wherein the average hit frequency of the start-bonus outcome is automatically increased by the processor at a predetermined time.

91. The gaming machine of claim 90, wherein said predetermined time is selected from a group consisting of a certain time of day, time of month, time of year, and a particular year.

92. The gaming machine of claim 87, wherein the gaming machine has a payback percentage defined as the average percent of each wager that is returned to players in basic and bonus game payouts, the payback percentage of the gaming machine being kept substantially the same by the processor as the average hit frequency of the start-bonus outcome is automatically adjusted by the processor.

93. The gaming machine of claim 87, wherein an average value of the bonus generated by the bonus feature is adjusted by the processor to compensate for the adjustments to the average hit frequency of the start-bonus outcome such that the average value of the bonus is decreased by the processor as the average hit frequency of the start-bonus outcome is increased by the processor.
